(19) United States
(12) Patent Application Publication
(10) Pub. No.: US 2005/0013907 A1
(43) Pub. Date: Jan. 20, 2005

(54) Food composition based on a substance derived from milk comprising conjugate linoleic acid glycerides

(75) Inventors: Anne Depierris, Jouy-En-Josas (FR); Didier Carcano, Paris (FR)

Correspondence Address: FINNEGAN, HENDERSON, FARABOW, GARRETT & DUNNER;LLP, 1300 I STREET, NW, WASHINGTON, DC, 20005, US

(73) Assignee: Compagnie Gervais Danone

(21) Appl. No.: 10/913,833

(22) Filed: Aug. 9, 2004

Related U.S. Application Data
(63) Continuation of application No. 09/807,268, filed on Jul. 11, 2001, now abandoned.

(30) Foreign Application Priority Data
Oct. 12, 1998 (FR) FR98 12731

(51) Int. Cl. C11C 3/00

(52) U.S. Cl. 426/330.2

(57) ABSTRACT

The invention concerns a food composition based on substances derived from milk, in the form of an oil-in-water emulsion, optionally over-run. The invention is characterised in that the proportion of fats is less than 50 wt. % and thatt comprises an efficient quantity of mono, di and/or triglyceride of one or several active isomers of conjugate linoleic acids (MG CLA: DG CLA and/or TG CLA). More particularly, the invention concerns fermented milk compositions, in particular yoghurt or fresh cream.

The present invention relates to a food composition, based on a substance derived from milk, in the form of an oil-in-water emulsion, comprising an effective amount of mono-, di- and/or triglyceride of one or more active isomers of conjugate linoleic acids (CLA MG, CLA DG and/or CLA TG). The invention relates more particularly to fermented dairy compositions, in particular yoghurts, crème fraîches or dairy specialities.

However, it should be clearly pointed out that the invention is directed in general toward the incorporation of CLA glycerides into food products consisting of milk-based starting materials taken in the broad sense, i.e. it also encompasses starting materials of plant origin, in particular cereals, which may act as substitutes or supplements for starting materials of dairy origin, in particular products based on soya milk and/or oat milk. The manufacture of food products of this type may be illustrated by patent application WO 99/27795.

Nowadays, a large proportion of people wish to reduce or maintain their body weight while at the same time maintaining a normal and varied diet. Furthermore, the maintenance of the body weight should be ensured while at the same time promoting muscle mass at the expense of adipose mass.

The active isomers of conjugate linoleic acids (CLA) are known to exert a positive action to reduce the assimilation of fats in mammals, especially in humans. They are also known to increase or prevent the decrease in the amount of proteins in mammals, especially humans. The active isomers of conjugate linoleic acids are in the form of a mixture mainly comprising 9,11-octadecadienoic acid and 10,12-octadecadienoic acid.

Dietetic compositions may be administered parenterally or orally. In the first case, they are compositions based on oil and on plant protein or on protein derived from eggs. For example, U.S. Pat. No. 5,760,082 discloses a dietetic food for humans containing from 0.5% to 1% by weight of CLA in triglyceride form.

On the other hand, as regards oral compositions, the CLAs are in free form. Mention may be made, for example, of patent application WO-A-94/16690 which discloses a dietetic composition supplemented, in a proportion of from 0.1% to 2% by weight thereof, with conjugate linoleic acids. However, these compositions are intended to improve the weight gain of animals. Patent application WO-A-96/06605 discloses a method for reducing fats in mammals, which consists in administering an effective amount of conjugate linoleic acids. Such acids are added in a proportion of from 0.01% to 2.0% to water-in-oil emulsions in replacement for 0.5% to 2% of the oil normally present in these emulsions.

U.S. Pat. No. 5,430,066 discloses a food composition for humans or animals, suffering from anorexia or weight loss following an immune stimulation, the nutrition of which is supplemented with conjugate linoleic acids.

Patent application WO-A-97/46230 discloses a method for maintaining an existing level of fat in the body and for maintaining the individual's weight using conjugate linoleic acids (CLAs). This method consists in adding an effective dose of CLA to foods such as margarine.

Patent application WO 96/38137 relates to the use of CLA to combat weight loss. To this end, said document discloses the production of CLA in milk by Lactobacilli.

U.S. Pat. No. 5,770,247 discloses a method for producing CLA in cows' milk. The CLA is in free form. In JP 06 276 939, the CLAs are also in free form.

Finally, patent application EP-A-0 779 033 discloses a fat-based spreadable paste such as a margarine, i.e. a water-in-oil emulsion, in which the fatty phase comprises 0.05% to 20% conjugate linoleic acid. Such a composition improves the lipid profile of the blood.

Moreover, it is known that conjugate linoleic acids are present naturally in a small amount in dairy products. This content ranges from 0.07% in yoghurts to 0.20% in certain cheeses with a high solids content (cf. H. LIN et al., J. Dairy Sci 78.2358-2365).

Dairy products based on an oil-in-water emulsion generally have a fat content of less than 50%. These oil-in-water emulsions may be unfermented, for instance skimmed milks, semi-skimmed milks, partially skimmed milks, whole milks and condensed milks. The emulsion can also be in the form of a fermented dairy product, in particular fromage frais, yoghurts or the like and other fermented dairy products.

It would be desirable to offer consumers a dairy food product which satisfies consumers' tastes, in the form of an oil-in-water emulsion which may be incorporated into a daily diet to ensure maintenance of the body weight in this diet, while at the same time promoting muscle mass at the expense of adipose mass.

It has been found, unexpectedly, that conjugate linoleic acids in lipophilic form can be incorporated into dairy products in the form of an oil-in-water emulsion and can satisfy the aim which the present invention proposes to achieve. Firstly, it has been found that conjugate linoleic acids in the form CLA MG, CLA DG and/or CLA TG have excellent stability in the dairy products that are the subject of the present invention (better resistance to oxidation and better processibility). Secondly, the use of CLA, all or some of which is in the form of mono-, di- and/or triglycerides according to the present invention, makes it possible to obtain dairy products, which may or may not be fermented, and which do not have the problems of poor taste encountered with CLAs in alkyl ester form. It is thus possible to introduce them in effective doses while at the same time retaining satisfactory organoleptic properties. Specifically, the Applicant has succeeded in uniformly incorporating CLA, in the form of glycero esters, into O/W emulsions containing less than 50% fat while avoiding the use of adjuvants. In addition, the CLA mono-, di- and/or triglycerides present in the compositions according to the invention are of increased bioavailability.

One subject of the present invention is to propose a dairy product supplemented with an effective amount of conjugate linoleic acid, which is incorporated into a daily diet and which has a fat content of less than 50% by weight.

According to the invention, the food composition based on a substance derived from milk, in the form of an oil-in-water emulsion, which is optionally overrun, is characterized in that the fat content is less than 50% by weight and in that it comprises an effective amount of mono-, di- and/or triglyceride of one or more active isomers of conjugate linoleic acids (CLA MG, CLA DG and/or CLA TG).

An effective amount of CLA according to the invention is defined relative to the daily intake, which is about 4 g of active CLA isomers/day. This daily intake expressed as a weight percentage of the product corresponds, depending on the type of food product, to a content of from 1% to 15% active CLAs in CLA MG, CLA DG and/or CLA TG form, preferably a content of between 1.5% and 13% and in particular 3% to 5% w/w.

Advantageously, 20% to 50% by weight of the fat, preferably 20% to 40% and in particular about 30%, consists of active CLA isomers in CLA MG, CLA DG and/or CLA TG form.

Linoleic acids are usually in the form of a mixture comprising at least 50% of the active isomers of 9,11-octadecadienoic acid and/or 10,12-octadecadienoic acid; the remainder of the mixture may consist of various plant oils based on saturated or unsaturated C₁₆ to C₂₀ acids.

Thus, the food composition according to the invention is characterized in that the active isomers of conjugate linoleic acids (CLAs) are chosen from the group consisting of 9,11-octadecanoic acid and 10,12-octadecanoic acid. The active isomers of conjugate linoleic acids (CLAS) may be a mixture of 9,11-octadecanoic acid and of 10,12-octadecanoic acid. The composition according to the invention may also comprise small proportions of other unsaturated or saturated fatty acids such as, for example, palmitic acid, stearic acid, oleic acid and/or unconjugated linoleic acid (C18:2 c9, c12). Said fatty acids may be in free or esterified form, in particular in the MG, DG and/or TG form.

Preferably, said active isomers of conjugate linoleic acids (CLAs) are preferably chosen from the following isomers:
9-cis-11-trans-linoleic acid,
10-trans-12-cis-linoleic acid.

Advantageously, the respective proportions of these two isomers may range from 0.5% to 99.5%. Thus, the mixture may consist, in equal parts, of 10t, 12c CLA and of 9c, 11t CLA, or alternatively the 10t, 12c CLA will represent 70% to 75% and up to 90% or 95% of the CLA isomers present; according to another aspect, the 9c, 11t CLA will be the major constituent of the mixture of isomers, of which it will represent 60% to 95%, preferably at least 70% and advantageously from 75% to 90% of the CLA composition. Conjugate linoleic acid compositions that are suitable for carrying out the invention are disclosed in particular in application WO 99/47135.

Advantageously, the food composition has a total fat content of between 1.5% and 35% by weight, preferably between 4% and 33%, this fat content in particular comprising the milk-based fat, the active CLA isomers in MG, DG and/or TG form, and optionally other plant oils.

These isomers and other forms of conjugate linoleic acid are essentially in the form of mono-, di- and triglycerides, although small amounts of CLA in free form or in the form of alkyl esters, these forms preferably representing less than 1% and advantageously less than 0.5% of the total CLA composition.

Preferably, the isomers will be essentially present in the form of TG, these isomers representing at least 30% w/w, preferably at least 50% and advantageously at least 60%, in particular from 60% to 90%.

According to the embodiments, up to 70% w/w and in particular from 20% to 30% of the various CLA isomers may, for example, be in the form of diglycerides.

The conjugate linoleic acids may be in a more or less purified form. One commercially available form comprises from 56% to 67% active isomers of conjugate linoleic acids; 19% to 34% oleic acid; 2% to 9% linoleic acid, these acids being in the form of triglycerides. Mixtures which may be mentioned, for example, are Selin® CLA-TG sold by Gruinau-Illertissen GmbH or the CLA sold by Natural Lipids under the brand name Tonalin™ CLA 75%-TG.

In general, said composition has a water activity of between 0.65 and 0.99, preferably between 0.75 and 0.99 and advantageously greater than 0.90, and an acidic or neutral pH.

The water activity of a product is a notion which is well known in the food sector; this measurement (abbreviated as Aw) measures the availability of water in a product. In most cases, this water activity is not proportional to the water content of the product.

By way of example, a fruit yoghurt comprises 82% water and has an Aw equal to 0.99; fromage frais contains 16% water and has an Aw equal to 0.99.

The methods for measuring the Aw of a product are known to those skilled in the art.

The dairy products may or may not be fermented. They may in particular be fermented fresh dairy products.

The expression “fermented fresh dairy products” means a dairy base which has been fermented following inoculation with lactic acid bacteria, and then mixed with other ingredients to obtain the fermented fresh dairy product. This fermented fresh dairy product stored at between 4 and 10° C. still contains live bacteria, preferably still at least 10² to 10⁸ and preferentially 10⁴ to 10⁵ live bacteria per ml for 4 to 6 weeks.

Preferably, the fermented dairy product is chosen from the group consisting of fromage frais, crème fraîches, dairy specialities, yoghurts or the like and other fermented dairy products containing, alone or as a mixture, live lactic acid bacteria such as S. thermophilus, L. bulgaricus, L. acidophilus, L. bifidus, L. lactococcus or Leuconostoc.

The expression “unfermented dairy product” means skimmed milks, semi-skimmed milks, partially skimmed milks, whole milks and condensed milks.

The composition may also contain one or more sugars. This presence may in particular improve the taste quality.

In order to improve the freshness and fondant properties of the composition, the degree of overrun of the composition is preferably greater than 30% and preferentially from 100% to 250%. Overrun is produced by injecting an inert gas. In certain cases, the degree of overrun may be up to or in excess of 300%. The composition may also comprise additives such as emulsifiers, flavorings and an overrun stabilizer.

It is also possible to incorporate one or more stabilizers such as gelatin, guar, xanthan or pectin in from 0.2% to 2% to give a creamier product which is more stable over time.

The composition may also be enriched with a well-known flavoring and/or solid dietary filler. Among the solid fillers that are mentioned in particular are fruit preparations, chocolate bits (chips), cereals and hazelnuts.

The pH is advantageously between 4 and 5 for a fermented dairy product.

According to one preferred variant, the composition is fermented and is chosen from the group consisting of yoghurts and crème fraîches.

According to another preferred variant, the food composition is formed from a yoghurt whose water activity is between 0.95 and 0.99, comprising, in percentages by weight:

| | |
|---|---|
| skimmed milk | 70 to 80 |
| dairy fat | 1 to 10 |
| advantageously | 1 to 3 |
| active isomers of CLAs in MG, DG and/or | 1 to 5 |
| TG form | |
| sugars | 1 to 6 |
| plant oil | 0 to 2 |
| other additives | 5 to 20. |

According to another variant, the food composition is formed from a crème fraîche whose water activity is between 0.95 and 0.99, comprising, as percentages by weight:

| | |
|---|---|
| skimmed milk | 40 to 60 |
| dairy fat | 5 to 35, |
| advantageously | 5 to 20 |
| plant oil | 0 to 10 |
| active isomers of CLAs in MG, DG and/or | 5 to 13, |
| TG form | |
| preferably about 10%. | |

The inventors have observed that the proportion of active CLA is stable in the food products in accordance with the invention. The CLA content is stable during the heat treatment. The total CLA content and the proportion of active isomers remains the same. Furthermore, the activity of the lactic acid ferments during the fermentation of yoghurt or the maturation of cream does not affect the CLA content, in particular of the active isomers of the finished product.

The examples below illustrate the different variants of the invention.

### EXAMPLE 1

The table below comprises the formula of a yoghurt in accordance with the invention.

| Ingredients | Yoghurt cream E |
|---|---|
| 0% fat milk | 75.18 |
| Cream 400 | 4.6 |
| Selin CLA-TG (*) | 2.7 |
| Sodium caseinate | 1.513 |
| DOMO 400 | 1.513 |
| Sugar | 3.5 |
| Vanilla syrup | 11 |
| Total | 100 |
| Dairy fat (%) | 1.88 |
| Total fat (%) | 4.58 |
| CLA-TG (%) | 1.62 |
| Product consumption (g/day) | 250 |
| CLA consumption (g/day) | 4.05 |

(*) Selin ® CLA-TG comprises 56% to 67% CLA, the remainder consisting of saturated or unsaturated C₁₆ or C₁₈ acid, in particular 19% to 34% oleic acid, 2% to 9% linoleic acid and up to 3% stearic acid.

The protein-standardized 0% fat milk is mixed with dairy fat supplemented with CLA. The mix, optionally sweetened, undergoes a pasteurization heat treatment at 95° C. for 5 to 10 min. The pasteurized mix is homogenized and then cooled to the fermentation temperature. It is inoculated with a thermophilic lactic acid ferment. The fermentation is continued until a pH of between 4.5 and 4.7 at a temperature of between 38 and 42° C. is obtained.

After cutting the coagulum, the product is smoothed out and then cooled to 20° C. Flavoring or a fruit preparation may be added to the finished product. The product is stored at a temperature of from 4 to 10° C. for a period of 28 days.

### EXAMPLE 2

### Composition According to the Invention Prepared from Tonalin™ CLA 75%-TG (Natural Lipids Ltd AS, Norway).

The table below comprises the formula of a yoghurt in accordance with the invention.

| Ingredients | % |
|---|---|
| 0% fat milk | 84.43 |
| Skimmed milk powder | 3.40 |
| Gelatin | 0.37 |
| Tonalin ™ CLA 75%-TG (*) | 3.75 |
| Sugar | 8.00 |
| Flavoring | 0.05 |
| Total | 100 |
| Product consumption (g/day) | 125 |
| CLA consumption (g/day) | 4.68 |

(*) Tonalin ™ CLA 75%-TG is a product available from Natural Lipids Ltd AS, which is a mixture of fatty acids of plant origin in the form of triglycerides containing 73.7% of various CLA isomers.

This product is described by the manufacturer as containing:

| | |
|---|---|
| palmitic acid (C18:0) | <9% |
| stearic acid (C18:0) | <4% |
| oleic acid (C18:1 c9) | 10-20% |
| linoleic acid (C18:2 c9, c12) | <3% |
| CLA (C18:2 conjugate) | 70-82% |
| CLA (C18:2 conjugate, c9, t11) | 30-38% |
| CLA (C18:2 conjugate t10, c12) | 30-38% |

The protein-standardized 0% fat milk is mixed with skimmed-milk powder, sugar and gelatin. The mixture then undergoes a pasteurization heat treatment over a temperature range from 75 to 100° C., preferably 95° C., for 5 to 10 min. The pasteurized mixture is homogenized and then cooled to fermentation temperature. It is inoculated with a thermophilic lactic acid ferment. The fermentation is continued until a pH of between 4.5 and 4.7 at a temperature of between 38 and 42° C. is reached.

After cutting the coagulum, the product is smoothed out and then cooled to a temperature ranging from 5 to 25° C., preferably 15° C. Flavoring or a fruit preparation may be added to the finished product. The product is stored at a temperature ranging from 4 to 10° C. for a period of 28 days.

### EXAMPLE 3

The table below comprises the formula of a matured cream in accordance with the invention. The product is prepared as in Example 1, except that the lactic acid ferment is mesophilic. The fermentation is thus carried out at a temperature of between 18 and 30° C.

| Ingredients | Creme fraiche E |
|---|---|
| 0% fat milk | 50.5 |
| Cream 400 | 32.5 |
| Selin ® CLA-TG (*) | 17 |
| Total | 100 |
| Dairy fat (%) | 13.03 |
| Total fat (%) | 30.03 |
| CLA-TG (%) | 10.2 |
| Product consumption (g/day) | 40 |
| CLA consumption (g/day) | 4.08 |

1. A food composition based on a substance derived from milk, in the form of an oil-in-water emulsion, which is optionally overrun, wherein the fat content of the food substance is less than 50% by weight and wherein the food substance comprises from 1 to 15% of mono-, di- and/or triglyceride of one or more active isomers of conjugate linoleic acids (CLA MG, CLA DG and/or CLA TG).

2. The food composition as claimed in claim 1, wherein the food composition comprises 1.5% to 13% of CLA MG, CLA DG, or CLA TG or a mixture thereof.

3. The food composition as claimed in claim 1, wherein the active isomers of conjugated linoleic acids (CLAs) are 9,11-octadecanoic acid and 10,12-octadecanoic acid or a combination of 9,11-octoadecanoic acid and 10,12-octadecanoic acid.

4. The food composition characterized as claimed in claim 1, wherein the active isomers of conjugated linoleic acids (CLAs) comprise a mixture of 9,11-octadecanoic acid and 10,12-octadecanoic acid.

5. The food composition as claimed in claim 1, wherein said active isomers of the conjugated linoleic acids (CLAs) are:
9-cis-11-trans-linoleic acid, or
10-trans-12-cis-linoleic acid.

6. The food composition characterized as claimed in claim 1, wherein the food composition comprises, as percentages by weight, 1.5% to 35% fat.

7. The food composition as claimed in claim 1, wherein the food composition comprises one or more additives chosen from sugars, emulsifiers, flavorings and overrun stabilizers.

8. The food composition characterized as claimed in claim 1, wherein the food composition is fermented and is a yoghurt or crème fraîches.

9. The food composition as claimed in claim 1, wherein the food composition has a water activity of between 0.9 and 0.99.

10. The food composition as claimed in claim 1, wherein the food composition is formed from a yoghurt whose water activity is between 0.95 and 0.99, comprising, as percentages by weight:

| | |
|---|---|
| skimmed milk | 70 to 80, |
| dairy fat | 1 to 10, |
| active isomers of CLAs in MG, DG and or TG form | 1 to 5, |
| sugars | 1 to 6, |
| plant oil | 0 to 2, |
| other additives | 5 to 20. |

11. The food composition as claimed in claim 1, wherein the food composition is formed from a crème fraîche whose water activity is between 0.95 and 0.99, comprising, as percentages by weight:

| | |
|---|---|
| skimmed milk | 40 to 60, |
| dairy fat | 5 to 35, |
| plant oil | 0 to 10, |
| active isomers of CLAs in MG, | 5 to 13[[,]] |
| DG and/or TG form | |

12. The food composition as claimed in claim 6, wherein the food composition comprises, as percentages by weight, 4% to 33% fat.

13. The food composition as claimed in claim 6, wherein the food composition comprises, as percentage by weight, 10% active isomers of CLAs in MG, DG, and/or TG form.
